(19) United States
(12) Patent Application Publication
(10) Pub. No.: US 2015/0269150 A1
(43) Pub. Date: Sep. 24, 2015

(54) SERVICE LOCATION RECOMMENDATIONS USING PREDICTIVE ANALYSIS

(71) Applicant: International Business Machines Corporation, Armonk, NY (US)

(72) Inventors: George P. Carper, Tucson, AZ (US); Socheat Sou, Tucson, AZ (US); Howard R. Zhao, Tucson, AZ (US)

(73) Assignee: International Business Machines Corporation, Armonk, NY (US)

(21) Appl. No.: 14/219,075

(22) Filed: Mar. 19, 2014

(51) Int. Cl. G06F 17/30

(52) U.S. Cl. CPC G06F 17/30029; G06F 17/30867; G06F 17/3053; G06F 17/30684; G06Q 50/12

(57) ABSTRACT

Service locations can be recommended based upon a user electronic device request specifying parameters that include a service type, an available time value and location information. Based upon the parameters, queries are sent to a service database to retrieve profile information about service locations that satisfy the service type and to a travel database to retrieve travel time information for the service locations that satisfy the service type. Time estimates for obtaining services at each of the service locations are generated by applying a service predicting algorithm using the profile information about service locations and the travel time information for the service locations. The service locations that satisfy the service type are filter as a function of the available time value and the time estimates. The filtering results are provided to the user device.

### BACKGROUND

The present disclosure relates to providing recommendations for service locations, and more specifically, to providing recommendations for service locations based upon an expected duration of services at different service locations.

Cognitive computing can be used to identify problems, potential solutions to a variety of different applications using one or both of structured and unstructured data. Certain systems have shown the ability to discern meanings in data that is traditionally difficult for computers to understand (e.g., double meanings of words, puns, rhymes, and inferred hints). While providing rapid responses, cognitive computing has shown promise in the ability to process vast amounts of information to make complex and subtle logical connections. This can include the use of natural language processing, hypothesis generation and evidence-based learning.

### SUMMARY

Embodiments are directed toward a computer-implemented method for recommending service locations that includes receiving, from a user electronic device, a request specifying parameters that include a service type, an available time value and location information. Based upon the parameters, a service database is queried to retrieve profile information about service locations that satisfy the service type and, also based upon the parameters, a travel database is queried to retrieve travel time information for the service locations that satisfy the service type. Time estimates for obtaining services at each of the service locations are generated by applying a service predicting algorithm using the profile information about service locations and the travel time information for the service locations. The service locations that satisfy the service type are filtered as a function of the available time value and the time estimates. The results of the filtering are provided to the user electronic device.

Consistent with embodiments, a system is configured to recommend service locations and includes one or more computer processor circuits configured with an input-output module configured to receive, from a user electronic device, a request specifying parameters that include a service type, an available time value and location information. The one or more computer processor circuits also include a query generation module that is configured to query, based upon the parameters, a service database to retrieve profile information about service locations that satisfy the service type and a travel database to retrieve travel time information for the service locations that satisfy the service type. A service predicting algorithm module is configured to generate time estimates for obtaining services at each of the service locations by applying a service predicting algorithm that uses the profile information about service locations and the travel time information for the service locations. A filter module is configured to filter the service locations that satisfy the service type as a function of the available time value and the time estimates.

Various embodiments are directed toward a computer program product for recommending service locations. The computer program product can include a computer readable storage medium having program instructions embodied therewith, the program instructions readable by at least one processing circuit to cause the at least one processing circuit to perform a method that includes receiving, from a user electronic device, a request specifying parameters that include a service type, an available time value and location information; querying, based upon the parameters, a service database to retrieve profile information about service locations that satisfy the service type; querying, based upon the parameters, a travel database to retrieve travel time information for the service locations that satisfy the service type; generating time estimates for obtaining services at each of the service locations by applying a service predicting algorithm that uses the profile information about service locations and the travel time information for the service locations; filtering the service locations that satisfy the service type as a function of the available time value and the time estimates; and providing results of the filtering to the user electronic device.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram of a system for generating service location recommendations, consistent with embodiments of the present disclosure;

FIG. 2 depicts a graphical user interface (GUI) for generating a service location recommendation request, consistent with embodiments of the present disclosure;

FIG. 3 depicts a graphical user interface (GUI) for presenting service location recommendations, consistent with embodiments of the present disclosure;

FIG. 4 is a block diagram of components in an service recommendation processing system and various devices connected thereto, consistent with embodiments of the present disclosure;

FIG. 5 shows a flow diagram for generating service location recommendations, consistent with embodiments of the present disclosure;

FIG. 6 depicts a cloud computing node according to embodiments of the present disclosure;

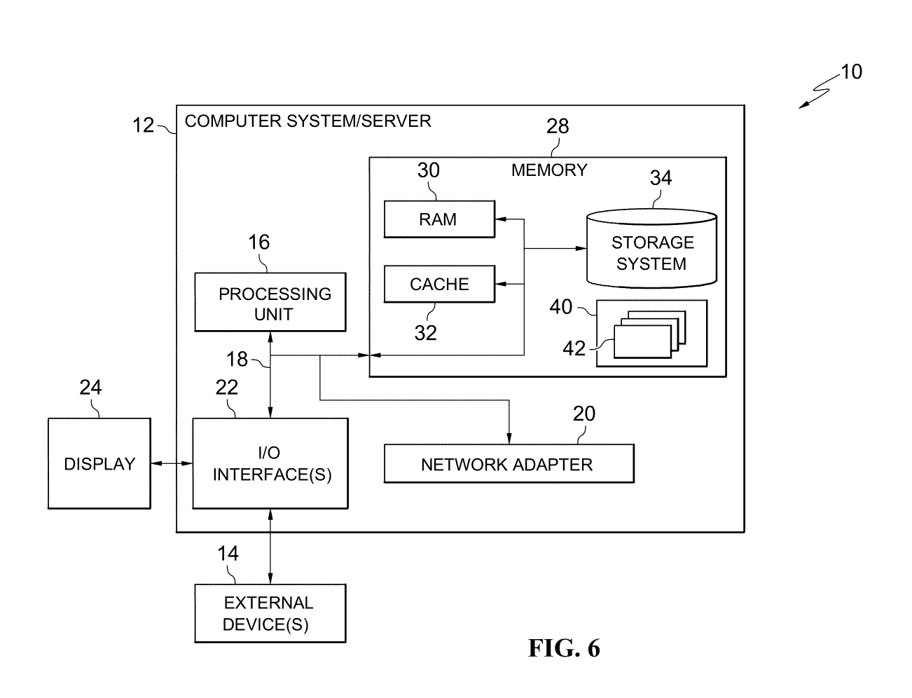

FIG. 7 depicts a cloud computing environment according to embodiments of the present disclosure; and

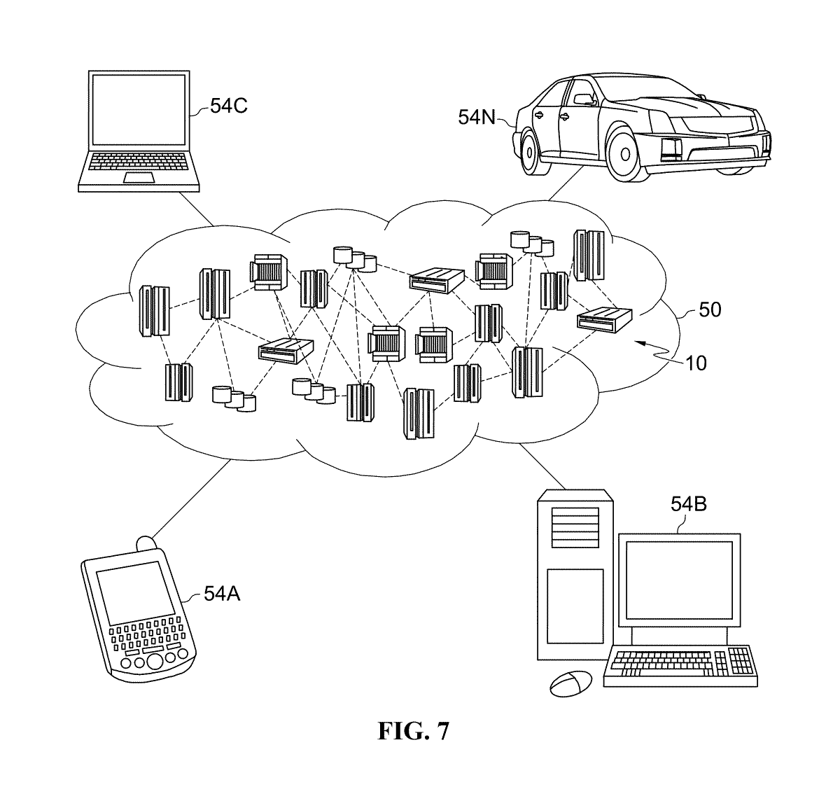

FIG. 8 depicts abstraction model layers according to embodiments of the present disclosure.

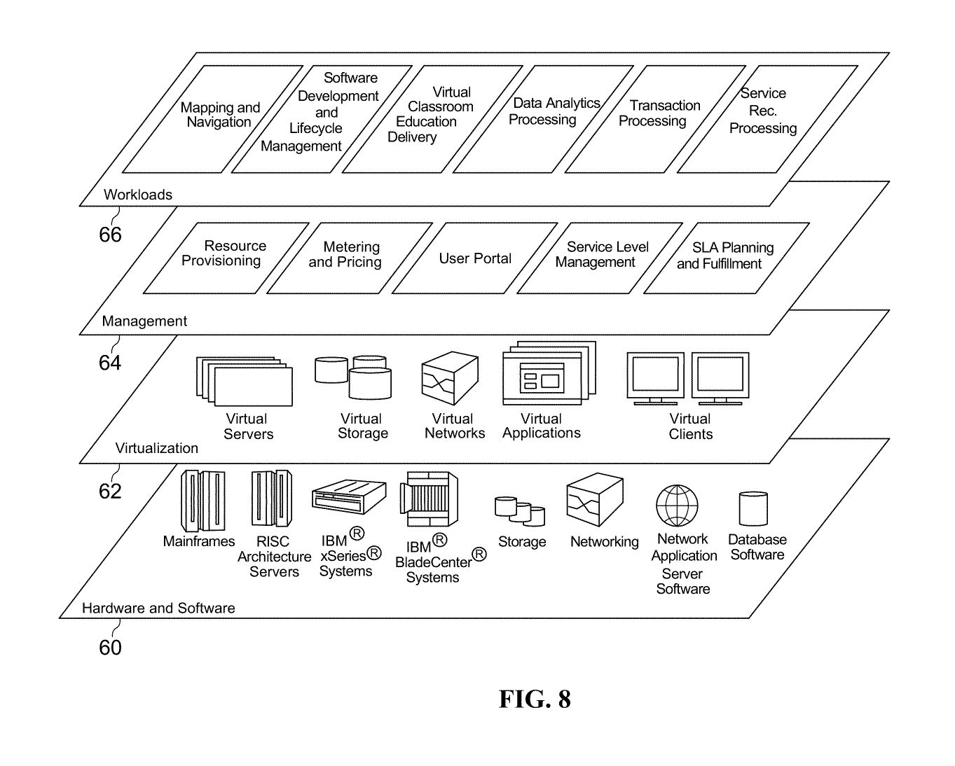

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to service location recommendations, more particular aspects relate to recommendations that are based upon predicted service times. While the present disclosure is not necessarily limited to such applications, various aspects of the disclosure may be appreciated through a discussion of various examples using this context.

Embodiments of the present disclosure are directed toward providing recommendations of service locations to an individual. In certain embodiments, predictive analysis, such as cognitive computing, can be used. For instance, the recommendations can be generated by using predictive analysis of a variety of service location factors to identify service locations that satisfy one or more recommendation criteria. A particular example of a recommendation criteria includes an amount of available time. For example, an individual may have an hour of time in which to complete a particular service, such as having lunch at a restaurant. The individual can request recommendations by providing relevant data (type of service desired, time limitations, current location, etc.) to a computer system. The computer system can be configured to apply a service predicting algorithm that uses service location factors to estimate the amount of time required to obtain the desired service at different service locations. The computer system can then provide recommendations to the user electronic device that are based upon the estimated amounts of time.

Various embodiments are directed toward the estimation of travel time to and from the service locations as part of the recommendation process. The travel time can be estimated based upon, among other things, a current location of the requesting individual relative to the service locations, mode of travel (car, bus, walking, etc.) and travel conditions (traffic, weather, road construction, etc.). Various embodiments also allow for the use of past travel history data for the individual, which can be particularly useful for accounting for differences between individuals (e.g., walking speed, driving habits and the like).

Certain embodiments include the use a variety of different data sources to estimate service time of different service locations. For instance, crowd-sourced data can be obtained from customers that have used the service locations. For example, data can be retrieved from websites, forums, blogs and other online sources of data. Natural language processing can be used to mine this data to create metadata that is relevant to estimated service times. This may include data from customer reviews (e.g., generating metadata by interpreting the context of reviews with information like “long wait,” “fast service,” or similar statements). Data can also be retrieved directly from individual users of the service locations. For example, software applications running on mobile devices, such as smart phones or tablets, can generate and provide service usage reports. In some examples, this data can be used to create real time information about service times (e.g., as might fluctuate based upon a restaurant waiting list).

Embodiments of the present disclosure are directed toward a system with one or more computer processor circuits that are configured to provide recommendations about service locations. The system can be configured to receive, from a user electronic device, a request specifying parameters that include a service type, an available time value and location information. The system can then query, based upon the parameters, a service database for profile information about service locations that satisfy the service type. Based upon the parameters, a travel module can be queried for travel time information for the service locations that satisfy the service type. The system can also generate time estimates for obtaining services at each of the service locations by applying a service predicting algorithm that uses the profile information about service locations and the travel time information for the service locations. The resulting service locations can be filtered based upon whether or not they satisfy the available time value (based upon the time estimates). The results of the filtering can then be provided to the user electronic device.

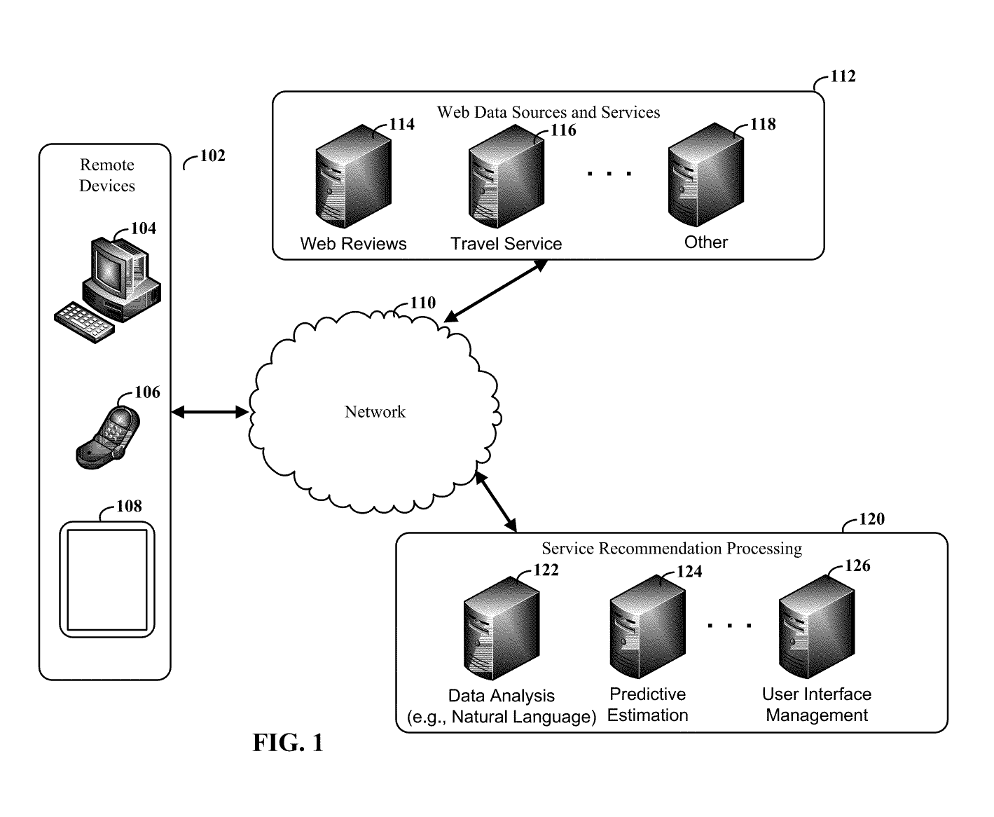

FIG. 1 depicts a block diagram of a system for generating service location recommendations, consistent with embodiments of the present disclosure. The various components in the system can communicate over one or more networks 110. The network 110 can include, but is not necessarily limited to, the global Internet, wide area networks (WAN), local area networks (LANs), private networks and combinations thereof. Remote devices 102 can include various devices used by individuals seeking service location recommendations, such as personal computers or laptops 104, smart phone 106 and tablets 108. Other devices with processing circuits and related capabilities can also be used.

Consistent with embodiments of the present disclosure, the remote devices 102 can be configured with software application(s) that allow individuals to request service location recommendations from a service recommendation processing (SRP) system 120. For instance, the remote devices 102 can provide selection options that allow the individuals to specify details about the desired service along with constraints, such as time and location. In response to selections by an individual, the remote devices can generate a request and transmit the request to the SRP system 120.

Consistent with embodiments, the service recommendation processing system 120 can include one or more computer processor circuits, servers, storage devices, associated hardware, which can each be configured to provide various functions described herein. For instance, computer server 122 can be configured to perform data analysis on data related to received requests; computer server 124 can be configured to use a service predicting algorithm to produce an estimation of service times and delays; and computer server 126 can be configured to provide and manage individual user interfaces. While these items are depicted as single and independent hardware devices, embodiments allow for multiple devices to be used for similar functions, for a single device to provide multiple functions and combinations thereof. For instance, one or more of the various functions discussed herein can be implemented in a virtual and/or cloud environment in which the functional components can be deployed on virtualized hardware/computer systems.

Consistent with a particular example, a user can install a software application on their remote (electronic) device 102. This software application can provide selection options relating to a desired service and provide information about constraints on when and where the service is desired. As a non-limiting example, the individual may specify they would like recommendations on restaurants for lunch or dinner. They individual can include information about what time they would like to take lunch and how long they have available for lunch. Information about their starting location can also be provided (e.g., either explicitly by the individual or using automated services such as using the Global Positioning System (GPS)) as well as information on types of transportation to consider (e.g., walking, driving or public transportation). From this information, a request can be generated and sent to the SRP system. The SRP system can then generate expected travel and service times for restaurants in the area. The expected service times can be generated using a service predicting algorithm that can include crowd sourced data. In response, the individual can be provided with a set of recommended restaurants that satisfy the constraints in the request.

Embodiments of the present disclosure are directed toward the use of a variety of different sources of data and metadata in generating an estimate of service time for restaurants and other types of service locations. For instance, the SRP system can import data from (third party) webservers 112. This may include data from webservers 114 that allow for customer reviews. This may include websites, forums, blogs, social media and other online content providers. Other capabilities include the use of data directly from participating service locations. For example, restaurants can subscribe to the service and agree to provide information about their wait times. This may include the average time between ordering and food delivery, the wait times for seating and the average overall time between entrance and exit for their customers. In some instances, the SRP system can be configured to allow restaurants (or other service providers) to include information about special expedited services (e.g., a lunch menu with a 30 minute or less guarantee).

Embodiments of the SRP system can also be configured to interface with travel services 116 to obtain information about travel times. For instance, the SRP system can use third party websites that offer estimates on travel times, recommended travel routes, and train or bus schedules. The SRP system can also be configured to interface with other online content providers 118, such as content providers for weather, sporting events and other factors that may be relevant to travel or service times.

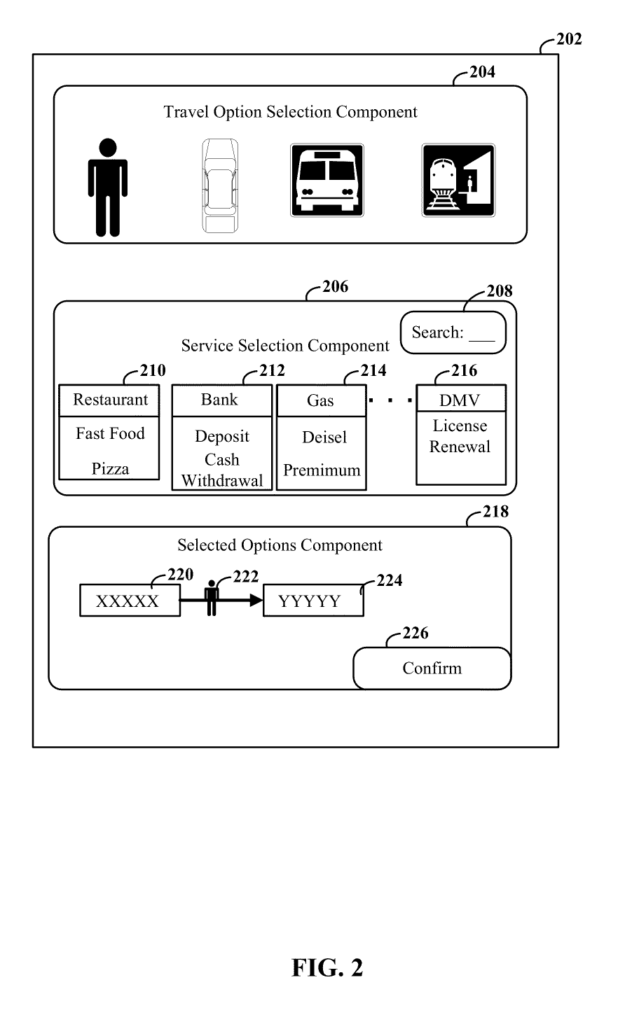

FIG. 2 depicts a graphical user interface (GUI) for generating a service recommendation request, consistent with embodiments of the present disclosure. Consistent with embodiments, GUI 202 can include a plurality of components that can be displayed on an active area of a display of a remote device, such as remote devices 102 from FIG. 1. The GUI can include a travel option selection component 204, which can present selectable options for travel. As an example, the options may include walking, automobile/car, public bus, train/subway or other modes of transportation. The GUI can be configured to allow an individual to select any combination thereof.

The GUI can also include a service selection component 206. The service selection component 206 can provide options for an individual to specify which type of service is desired. For instance, the GUI can include options to select service types that are related to restaurants 210, banks 212, gasoline 214, department of motor vehicles 216, other services and combinations thereof. In certain embodiments, the displayed service types can be selected based upon a default set of options. The system can also be configured to display service types using profile data of the individual, or upon other information, such as location and time of day. In certain embodiments, the GUI can include a search field 208 that allows an individual to search for different service types. In some instances, the search function can be linked to a map/travel service that can provide data to populate a selection option. Embodiments allow for the selection options to include additional detailed selection criteria. For example, the individual can specify details such as: restaurant type (e.g., fast food, pizza), banking service desired (e.g., deposit, loan), type of gas (e.g., diesel, premium unleaded), and type of licensing service (e.g., license renewal).

The GUI can also be configured to display the selected options and to allow the individual to confirm their selections. For instance, a first field 220 may specify a current location and a second field 224 may specify a first type of desired service (e.g., fast food restaurant). An arrow connecting the two fields can display the selected travel options 222. Additional service types can also be added to the selections. For example, an individual may specify that they wish to eat and fill up their vehicle with gas as part of a single trip (perhaps over their lunch hour). They might also specify a different return or destination location (e.g., they would like to have lunch on the way to another (end) location). They can specify both service types and transportation as only by automobile. Additional options can be included, such as specifying priorities to different service types and allowing for service types to be completed in different (or any) possible order. In the above example, the individual could specify that it is acceptable to fill up their vehicle before or after they have lunch. This information can then be included in a request for recommendations, which can be sent upon selection of the confirmation component 224.

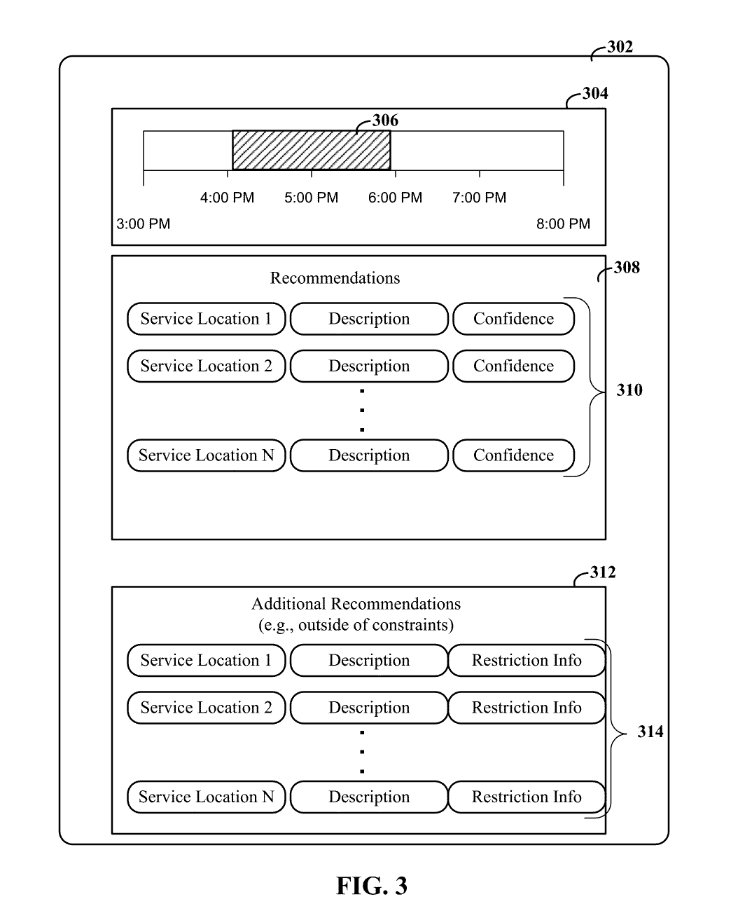

FIG. 3 depicts a graphical user interface (GUI) for presenting service recommendations, consistent with embodiments of the present disclosure. GUI 302 can include a plurality of components designed to display service location recommendations to an individual.

Recommendations component 308 can display recommended service locations 310. Along with name of the service locations, the recommendations component 308 can be configured to provide other useful information. This can include of a description of relevant information for each service location. One relevant piece of information can include expected time to complete the service. Consistent with embodiments, elements of the description can be derived from crowd sourced data. For instance, the description of a restaurant may identify the type of food as well as a rating that can be derived from online sources, such as websites with customer reviews and comments.

The recommended service locations 310 can include other information, such as the confidence in the description information. In particular, the SRP system used to generate the estimated service time can also be configured to produce a confidence level associated with the estimation. This confidence level can be derived from factors including, but not limited to, the amount of available data, the type of data, the sources of the data, the age of the data and the type of service. For instance, the service predicting algorithm can be configured to assign a lower confidence score to estimations based upon older data or for services that are highly volatile in their respective service times.

In some embodiments, the GUI 302 can also include a time restriction component 304. The time restriction component 304 can be configured to display the desired start time(s) and the amount of time available for the service. The particular example shown in FIG. 3 includes a window 306 that shows a desired start time near 4:00 PM and an available time of about 2 hours. Embodiments allow for dynamic adjustment to this window 306. In response, the recommendations can be adjusted accordingly. For instance, an individual may adjust the window to begin at 5:00 PM. The SRP system can then generate a new set of recommendations based upon this new window. The recommendations can be automatically populated in the recommendations component 308.

According to certain embodiments, the individual can select one or more of the service locations. In response to this selection, the software application can perform actions such as triggering a reminder/alarm at, or before, the start time and launching a navigation application to provide driving instructions to the selected service location(s).

In certain embodiments, the SRP system can be configured to provide additional recommendations that may not meet the express constraints provided by the individual. These recommendations can be displayed in additional recommendations component 312 as recommendations 314. For instance, a user may specify that they are interested in eating at a particular type of restaurant. As part of the recommendation process, the SRP system can identify closely associated alternatives to the particular type of restaurant (e.g., “burgers” may be associated with “sandwiches”) and include them in the additional recommendations. The associations can be generated based upon a variety of factors, such as crowd sourced preference matching.

The GUI displays of FIGS. 2 and 3 are provided as examples and not meant to be limiting. Various other configurations and components can be used and included as part of the various embodiments discussed herein.

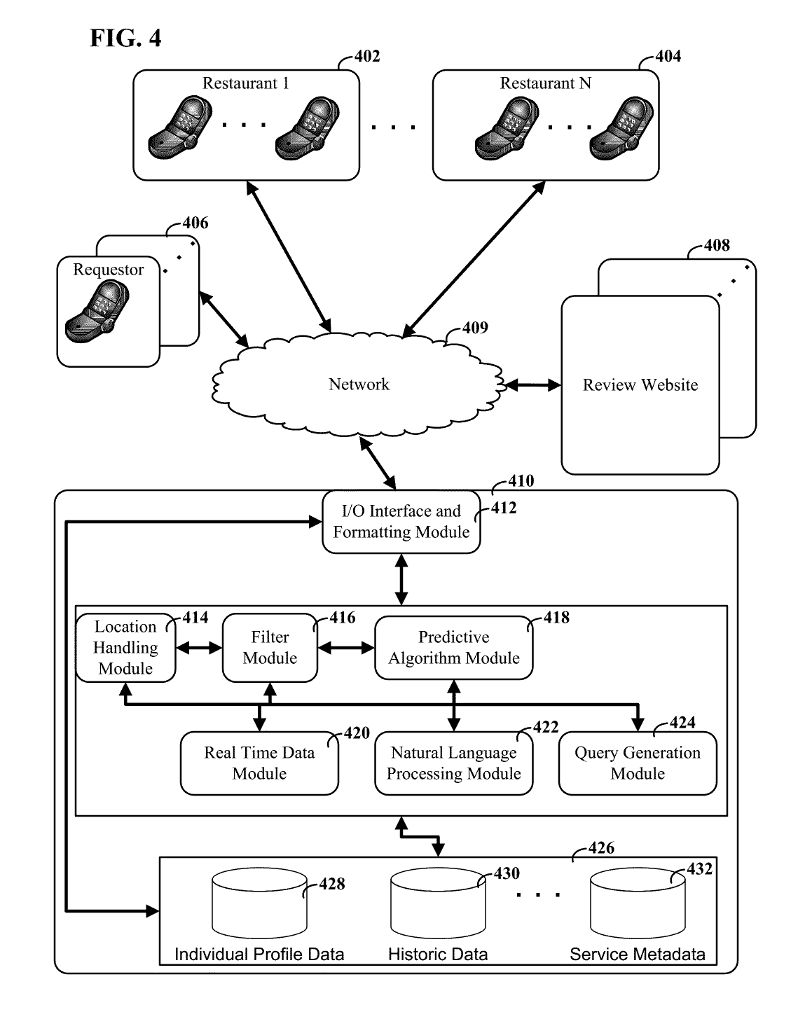

FIG. 4 is a block diagram of components in an SRP system and various devices connected thereto, consistent with embodiments of the present disclosure. The displayed SRP system 401 includes a variety of modules configured to provide various functions. Input/output (I/O) interface module and formatting module 412 can be configured to manage access to remote devices. This can include formatting of data received and transmitted from different sources. For instance, the I/O interface module 412 can be configured to receive service recommendation requests from remote requesting devices 406, and also to provide service location recommendations generated to the SRP system in response to such requests.

As discussed herein, the SRP system can be configured to generate service location recommendations based upon data from a multitude of different data sources. These potential data sources can include mobile devices used by individuals at service locations (e.g., at restaurants 1-N (402, 404)). The I/O interface module 412 can be configured to receive data from each of the devices at the locations 402, 404. For instance, the devices can include smartphones that include a software application that reports entrance and exit times from different service locations to an Internet Protocol (IP) address associated with the I/O interface module.

Other potential data sources include online review websites, forums, blogs, social networking sites and other online sources, as denoted by websites 408. The I/O interface module 412 can be configured to retrieve data from these sites in a variety of different manners. This can include customized interfaces that allow access direct to databases associated with the sites 408. Another example of a data gathering option includes different forms of web scraping (web harvesting or web data extraction). This data can then be stored in databases 426 for use in generating recommendations.

According to embodiments of the present disclosure, databases 426 can include an individual profile database 428, which can store individual preferences, individual travel time history, individual service time history and other information. Each request can include an identifier of the individual, which can be used to retrieve the appropriate profile data. Additional security can be used by requiring some type of authentication (e.g., login and password).

In certain embodiments, databases 426 can include a historic database 430, which can store usage data about service locations. For instance, data about service time can be collected from individuals using the SRP system, from social networking sites, from review sites or from other sources as discussed herein. This information can be stored and, as more data is accumulated overtime, the SRP system can use the data to adjust estimations of service times (e.g., using cognitive computing, evidence based learning, learning algorithms and/or regression analysis).

Embodiments of the present disclosure are directed toward the use of metadata describing service locations, which can be stored in a service metadata database 432. For instance, the metadata may describe attributes of the service locations (e.g., menus, parking, consumer ratings, pricing and combinations thereof).

When a requestor 406 wishes to use the recommendation service, they can specify the desired parameters, which can then formatted into one or more communications as a request that is provided to the SRP system. In response to the request, the query generation module 424 can query a database to identify a set of service locations that match a preliminary set of parameters in the request. For instance, the query generation module 424 can generate a query for service locations that match the parameters: (restaurant); (fast food); and (within 20 miles of current location). The query can be sent to one or more a databases containing service locations. This database can be part of the SRP system, provided by a remote (third party) service and combinations thereof. For instance, the query can be sent to a location handling module 414 that is configured to interface with a map service that can provide a list of service locations within a certain geographic area.

In certain embodiments, location handling module 414 can be configured to retrieve data about (and/or determine) travel times between a starting location specified in the request and each of the service locations. For instance, the location handling module can query a remote travel service for travel options and times from the starting location to each of the service locations. In some embodiments, individual profile data can be used to adjust the travel time (e.g., if the individual prefers highway driving over side streets or vice versa). Travel times can also be determined for different modes of transportation (e.g., personal automobile and public transportation). Data can also be retrieved from other relevant sources including sources providing information relating to, but not necessarily limited to, weather, sporting events and public transportation schedules. This can be particularly useful for providing an accurate travel time estimate for travel time several hours or evens days in the future (e.g., as travel conditions may change significantly overtime).

The service locations provided in response to the query can then be provided to the service predicting algorithm module 418. Service predicting algorithm module 418 can be configured to use data from natural language processing module 422 in combination with cognitive computing and evidence based learning in order to generate profile data useful for estimating service times for the service locations. For instance, natural language processing can be used to help interpret unstructured data retrieved from online reviews, forums and other sources. As a non-limiting example, data from the natural language processing can be used along with data from actual service times of certain service locations to infer service times of service locations having similar reviews, but perhaps not having actual service time data. As discussed herein, the profile data for the service locations can be used in response to queries generated from user requests.

Consistent with embodiments, the service predicting algorithm module 418 can be configured to applying weight factors to how much consideration is given to various sources of data. For instance, the weights can be used to reflect changes to service locations overtime by giving more weight to newer data. Weighting can also be applied to other factors.

In certain embodiments, the service predicting algorithm module can be configured to use real time (or near real time) data from individuals using the various services or from the service locations themselves. For instance, individuals with smartphones can provide information about when they enter and leave a service location. Moreover, if the individuals had previously requested service recommendations from the SRP system, data from their request can be included to provide more accurate data on their particular service (e.g., by specifying what specific service they were planning to use). In other instances, the service location can provide relevant information. For example, the restaurant may have a system that tracks reservations, wait lists and possibly the times at which customers leave the restaurant (e.g., by way of recording their payment). The type of information can be provided by linking the restaurant system to the SRP system.

Various embodiments are directed toward linking the SRP system to a reservation system of the restaurant. This may allow the SRP system to assign a high confidence value to time estimates for restaurants with reservation openings at the relevant times. Moreover, certain embodiments allow the SRP system to submit a reservation request for an individual upon selection of a particular restaurant.

According to embodiments, filter module 416 can be configured to use the travel times and estimated service times to filter out service locations that do not meet the time constraints of the request (e.g., the travel and service time exceed the time allotted in the request). The results for the filtering can then be provided to the corresponding requesting device.

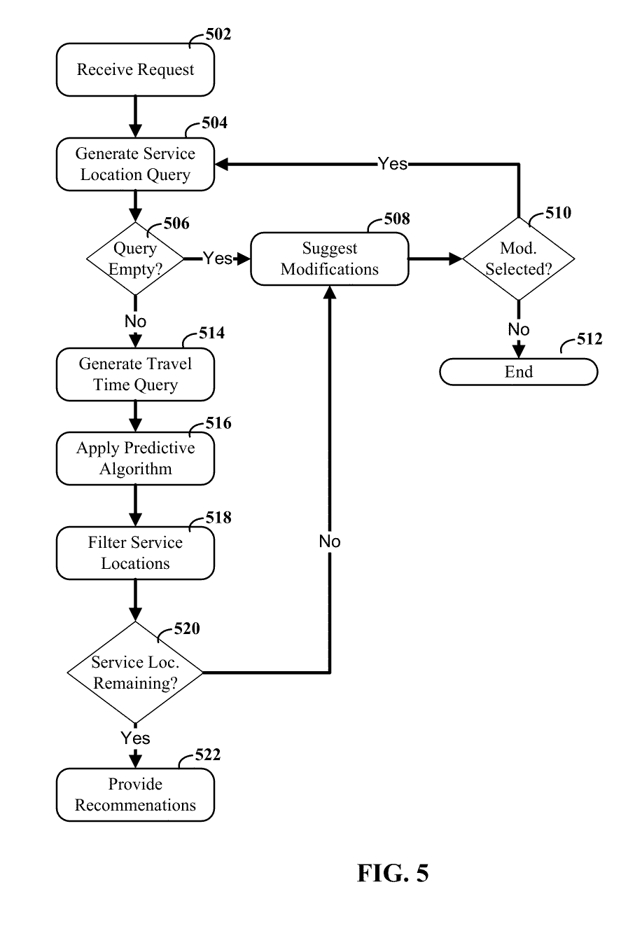

FIG. 5 shows a flow diagram for generating service location recommendations, consistent with embodiments of the present disclosure. An SRP system can receive a request from remote device (e.g., cellular phone, tablet, computer or other devices with processing circuits), as shown by block 502. Consistent with embodiments, the request can include a service type, starting location and amount of available time. Other parameters can also be provided, such as additional service types, travel mode selections and the number of individuals in need of the service. For example, a “time-to-eat” estimation might be different for a single person versus a party of four people. However, with crowd-sourced data, restaurant turnover rate can be modeled and then be applied to estimate the time needed for larger groups. In certain embodiments, the algorithm could distinguish between single (1), small group (e.g., 2-4), and large group (e.g., 4+) estimates. The particular definitions for small and large groups can be adjusted based upon discovered differences in the estimated service times.

The SRP system can then generate a query for service locations near the starting location, as shown by block 504. For instance, the SRP system can generate a query for all service locations within a radius that is determined as a function of the amount of available time. In particular, if the individual has more time available, they can potentially use the extra time to travel service locations further away.

The SRP system can next determine whether or not any (or more than a threshold amount of) service locations are returned as part of the query, as shown by block 506. If the query results are empty, then the SRP system can suggest that the query be modified, as shown by block 508. For instance, an individual might request recommendations for restaurants that serve pizza with only 30 minutes of available time and starting at their current location (as can be determined using GPS services on a mobile device of the individual). The SRP system may look for any pizza service locations within 10 miles. If none are found, then the SRP system might suggest either expanding the amount of time (to allow for additional travel time) or other types of restaurants.

The SRP system can then determine whether or not the individual is willing to modify the constraints, as shown by block 510. If they do modify their constraints, then the SRP can generate a new query based upon the modified constraints, as shown by block 504. If they do not wish modify their constraints, then the SRP system can end the recommendation process, as shown by block 512.

If the SRP system determines that the query results are not empty (or meets a certain threshold number), then a travel time query can be generated for the service locations in the query results, as shown by block 514. The SRP system can also apply a service predicting algorithm to determine expected/estimated service times for the service locations, as shown by block 516.

Using the results of the travel time query and the service predicting algorithm, the SRP system can filter out service locations that do not meet the time constraints that were provided in the recommendation request, as shown by block 518. The SRP system can next determine whether or not there are any (or at least a threshold amount) of service locations left after the filtering, as shown by block 520. If there are not enough service locations left, then the SRP system can suggest that the query be modified, as shown by block 508. If there are enough service locations, then the SRP system can provide the recommendations to the requesting individual, as shown by block 522.

The flow diagrams, algorithms, modules and related discussion are provided as examples. It is understood that variations are possible, including the performance of various functions out of order. For instance, filtering of service locations can occur at different points in the process and use a multitude of additional or different parameters.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32.

Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and a service recommendation processing system.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method for recommending service locations, the method comprising:
receiving, from a user electronic device, a request specifying parameters that include a service type, an available time value and location information;
querying, based upon the parameters, a service database to retrieve profile information about service locations that satisfy the service type;
querying, based upon the parameters, a travel database to retrieve travel time information for the service locations that satisfy the service type;
generating time estimates for obtaining services at each of the service locations by applying a service predicting algorithm using the profile information about service locations and the travel time information for the service locations;
filtering the service locations that satisfy the service type as a function of the available time value and the time estimates; and
providing results of the filtering to the user electronic device.

2. The method of claim 1, further comprising generating the profile information about the service locations by applying natural language processing to unstructured data describing the service locations that satisfy the service type.

3. The method of claim 1, further comprising generating the profile information about the service locations by obtaining actual service times from mobile devices of individuals using the service locations.

4. The method of claim 1, wherein the service predicting algorithm is configured to weight the profile information about service locations according to an age of the data.

5. The method of claim 1, further comprising generating the profile information about the service locations by interfacing with a reservation system at a restaurant.

6. The method of claim 1, wherein the travel time information for the service locations that satisfy the service type is based upon a current location of the user electronic device.

7. The method of claim 1, further comprising querying, based upon the parameters, a travel database to retrieve travel time information from the service locations that satisfy the service type to a destination that is different than a current location of the user electronic device.

8. The method of claim 1, wherein the service type is restaurant.

9. The method of claim 8, further comprising generating the profile information about service locations by analyzing unstructured data from online reviews.

10. A system for recommending service locations, the system comprising:
one or more computer processor circuits configured with:
an input-output module configured to receive, from a user electronic device, a request specifying parameters that include a service type, an available time value and location information;
a query generation module configured to:
query, based upon the parameters, a service database to retrieve profile information about service locations that satisfy the service type;
query, based upon the parameters, a travel database to retrieve travel time information for the service locations that satisfy the service type;
a service predicting algorithm module configured to generate time estimates for obtaining services at each of the service locations by applying a service predicting algorithm that uses the profile information about service locations and the travel time information for the service locations; and
a filter module configured to filter the service locations that satisfy the service type as a function of the available time value and the time estimates.

11. The system of claim 10, wherein input-output module is further configured to provide results from the filter module to the user electronic device.

12. The system of claim 10, wherein the service predicting algorithm module is further configured to apply natural language processing to unstructured data describing the service locations that satisfy the service type.

13. The system of claim 10, wherein the service predicting algorithm module is further configured to obtain actual service times from mobile devices of individuals at the service locations.

14. The system of claim 10, wherein the service predicting algorithm module is further configured to weight the profile information about service locations according to an age of the data.

15. The system of claim 10, wherein the input-output module is further configured to interface with a reservation system at a restaurant.

16. The system of claim 10, wherein the query generation module is further configured to querying, based upon the parameters, the travel database to retrieve travel time information from the service locations that satisfy the service type to a destination that is different than a current location of the user electronic device.

17. The system of claim 16, wherein the query generation module is further configured to use global positioning system (GPS) data from the user electronic device to determine the current location of the user electronic device.

18. The system of claim 10, wherein service predicting algorithm module is configured to use evidence-based learning.

19. A computer program product for recommending service locations, the computer program product comprising a computer readable storage medium having program instructions embodied therewith, the program instructions readable by at least one processing circuit to cause the at least one processing circuit to perform a method comprising:
receiving, from a user electronic device, a request specifying parameters that include a service type, an available time value and location information;
querying, based upon the parameters, a service database to retrieve profile information about service locations that satisfy the service type;
querying, based upon the parameters, a travel database to retrieve travel time information for the service locations that satisfy the service type;
generating time estimates for obtaining services at each of the service locations by applying a service predicting algorithm that uses the profile information about service locations and the travel time information for the service locations;
filtering the service locations that satisfy the service type as a function of the available time value and the time estimates; and
providing results of the filtering to the user electronic device.
